(19) United States
(12) Patent Application Publication
(10) Pub. No.: US 2014/0226086 A1
(43) Pub. Date: Aug. 14, 2014

(54) TOUCH PANEL HAVING ELECTROSTATIC PROTECTION

(71) Applicants: WINTEK CORPORATION, Taichung City (TW); Wintek (China) Technology Ltd., Dongguan City (CN)

(72) Inventors: Kuan-Yu Chu, Taichung City (TW); Chun-Cheng Huang, Yunlin County (TW); Chiu-Mei Liu, Taichung City (TW); Ming-Wu Chen, Nantou County (TW); Chin-Pei Hwang, Taichung City (TW); Chen-Fu Huang, Taichung City (TW); Yu-Ching Wang, Taichung City (TW)

(73) Assignees: WINTEK CORPORATION, Taichung City (TW); Wintek (China) Technology Ltd., Dongguan City (CN)

(21) Appl. No.: 14/174,904

(22) Filed: Feb. 7, 2014

(30) Foreign Application Priority Data
Feb. 8, 2013 (TW) 102105317

(51) Int. Cl. G06F 3/041

(52) U.S. Cl. CPC G06F 3/041
USPC 349/12

(57) ABSTRACT

Touch panel having electrostatic protection is provided. The touch panel includes a substrate, a plurality of sensing electrodes, a plurality of conductive wires and an electrostatic protection line. The substrate has a touch sensitive area and a periphery area surrounding the touch sensitive area. The inner part of the periphery area is a first layout area. The outer part of the periphery area is a second layout area. The sensing electrodes are formed in the touch sensitive area. The conductive wires are disposed in the first layout area. The electrostatic protection line is disposed in the second layout area and adjacent to the conductive wires. The width of the electrostatic protection line is greater than that of the conductive wires. The distance separating the outside of the electrostatic protection line from the border of the substrate is smaller than 48.12 mm and greater than or equal to 0.3 mm.

This application claims the benefit of Taiwan application Serial No. 102105317, filed Feb. 8, 2013, the subject matter of which is incorporated herein by reference.

### BACKGROUND OF THE INVENTION

1. Field of the Invention

The invention relates in general to a touch panel, and more particularly to a touch panel having electrostatic protection.

2. Description of the Related Art

Since the development of the touch technology, touch panels have occupied a significant market share in the market of electronic products. The touch display panels integrating touch and display functions are now available in the market. The touch display panels can be used in portable consumer electronic products such as mobile phones, notebook computers, Tablet PCs and digital cameras.

Most of the electronic products integrating touch function that are available in the market are realized by assembling a touch panel and a display panel together and the touch signal and the display signal are transmitted via the signal lines of the touch panel and the display panel respectively. Besides, the touch panel further integrating with the touch circuit on a substrate accordingly has the advantages of lower cost, higher transmittance and thinner thickness. Conversely, it has deteriorated structural protection and cannot provide sufficient electrostatic protection. According to the popular electrostatic protection mechanism, instantaneous large current is vented via the conductive wires that need to be additionally provided. Since the electrostatic protection mechanism cannot cover the entire touch panel, such that the effect of electrostatic protection will be decreased. To improve the mentioned drawback, an electrostatic shielding film will be provided. However, it will decrease the transmittance of the light of the touch panel.

### SUMMARY OF THE INVENTION

The invention is directed to a touch panel having electrostatic protection for enhancing the effect of electrostatic protection without affecting the layout area of the touch panel.

According to one embodiment of the present invention, a touch panel having electrostatic protection is provided. The touch panel includes a substrate, a plurality of sensing electrodes, a plurality of conductive wires and an electrostatic protection line. The substrate has a touch sensitive area and a periphery area surrounding the touch sensitive area. The inner part of the periphery area is a first layout area, and the outer part of the periphery area is a second layout area. The sensing electrodes are formed in the touch sensitive area. The conductive wires are disposed in the first layout area, and the electrostatic protection line is disposed in the second layout area and adjacent to the conductive wires. The width of the electrostatic protection line is greater than the width of each of the conductive wires, and a distance separating an outside of the electrostatic protection line from at least one border of the substrate is smaller than 48.12 mm and greater than or equal to 0.3 mm.

According to another embodiment of the present invention, a touch panel having electrostatic protection is provided. The touch panel includes a substrate, a plurality of sensing electrodes, a plurality of conductive wires and an electrostatic protection line. The substrate has a touch sensitive area and a periphery area surrounding the touch sensitive area. The inner part of the periphery area is a first layout area, and the outer part of the periphery area is a second layout area. The sensing electrodes are formed in the touch sensitive area. The conductive wires are disposed in the first layout area, and the electrostatic protection line is disposed in the second layout area and adjacent to the conductive wires. The width of the electrostatic protection line is greater than the width of each of the conductive wires. The electrostatic protection line is separated from an edge of the touch sensitive area by a distance expressed as: d=GR+nV+(n−1)S+GL. Wherein, GR represents the distance between the electrostatic protection line and the conductive wire closest to the electrostatic protection line; n represents the quantity of conductive wires; V represents the equal line width of each conductive wire; S represents the equal pitch between two adjacent conductive wires; GL represents the distance between the edge of the touch sensitive area and the conductive wire closest to the edge of the touch sensitive area, and the distance d is between 0.06˜11.52 mm.

According to an alternate embodiment of the present invention, a touch panel having electrostatic protection is provided. The touch panel includes a substrate, a plurality of sensing electrodes, a plurality of conductive wires, a first electrostatic protection line and a second electrostatic protection line. The substrate has a touch sensitive area and a periphery area surrounding the touch sensitive area. The inner part of the periphery area is a first layout area, and the outer part of the periphery area is a second layout area. The sensing electrodes are formed in the touch sensitive area. The conductive wires and the first electrostatic protection line are disposed in the first layout area, and the first electrostatic protection line is disposed between the conductive wires and the touch sensitive area. The second electrostatic protection line is disposed in the second layout area and adjacent to the conductive wires, and the second width of the electrostatic protection line is greater than the width of the conductive wires. A distance separating an outside of the second electrostatic protection line from at least one border of the substrate is smaller than 48.12 mm and greater than or equal to 0.3 mm.

According to another alternate embodiment of the present invention, a touch panel having electrostatic protection is provided. The touch panel includes a substrate, a plurality of sensing electrodes, a plurality of conductive wires and an electrostatic protection line. The substrate has a touch sensitive area and a periphery area surrounding the touch sensitive area, the periphery area has at least one layout area. The sensing electrodes are formed in the touch sensitive area. The conductive wires and the electrostatic protection line are disposed on the layout area, and the electrostatic protection line is disposed between the touch sensitive area and the conductive wires.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIGS. 1 and 2 respectively are a top view and a partial enlargement of a touch panel having electrostatic protection according to an embodiment of the invention.

FIGS. 3A˜3E are cross-sectional views of electrostatic protection line having different widths along cross-sectional line I-I of FIG. 1 or FIG. 2.

FIG. 3F is a schematic diagram of a touch panel with a transparent cover plate and a substrate bonded to each other.

FIG. 4 is a cross-sectional view of a periphery area of a touch panel according to another embodiment of the invention.

### DETAILED DESCRIPTION OF THE INVENTION

According to the touch panel having electrostatic protection of the embodiment, a conductive ring with equal or unequal line width is used as an electrostatic protection line surrounding a periphery area of the touch sensitive area. The periphery area further has a first layout area and a second layout area. The electrostatic protection line is disposed in the second layout area and adjacent to a plurality of conductive wires disposed in the first layout area. In an embodiment, the line width of the electrostatic protection line is greater than the line width of each conductive wire to enhance the effect of electrostatic protection. For example, the width of the electrostatic protection line is greater than 20 μm (0.02 mm), and the width of the electrostatic protection line can be adjusted according to the area of the first layout area. The larger the width, the larger the coverage of electrostatic protection, such that the electrostatic protection line can cover the entire touch panel and provide better effect of electrostatic protection.

A number of embodiments are disclosed below for elaborating the invention. However, the embodiments of the invention are for detailed descriptions only, not for limiting the scope of protection of the invention.

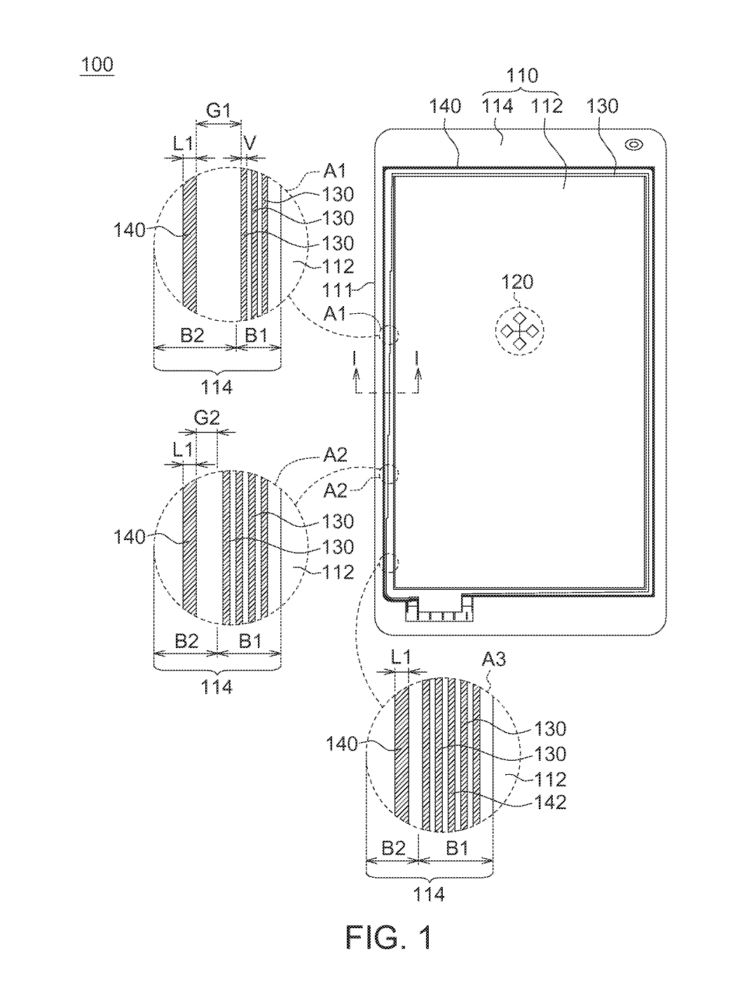

Referring to FIGS. 1 and 2, a top view and a partial enlargement of a touch panel having electrostatic protection 100 according to an embodiment of the invention are respectively shown. The touch panel 100 includes a substrate 110, a plurality of sensing electrodes 120, a plurality of conductive wires 130 and an electrostatic protection line 140. The substrate 110 has a touch sensitive area 112 and at least one periphery area 114. The periphery area 114 can surround the touch sensitive area 112 (as indicated in FIGS. 1 and 2) or can be disposed on at least one border (not illustrated) of the substrate 110. The touch sensitive area 112 is correspondingly arranged to a display area of a display device such that the user can operate the display device by touching, dragging or clicking in the touch sensitive area 112. The sensing electrodes 120, formed in the touch sensitive area 112, generate a control signal in response to the user's operation. Thus, the display panel (not illustrated) disposed below the touch panel 100 can display a corresponding message on the display area according to the touch signal. In addition, the sensing electrodes 120 can be extended to the periphery area 114 from the touch sensitive area 112 to provide touch operation for the periphery area 114.

As indicated in FIG. 1, a plurality of conductive wires 130 are disposed on the inner side of the periphery area 114, that is, in the first layout area B1, for transmitting the touch signal and/or the control signal associated with the touch signal. The first layout area B1 can be an area in which the conductive wires 130 are arranged. Specifically, a disposed area of the total conductive wires 130 is equal to the first layout area B1, for example. Meanwhile, a total of space areas between two neighboring conductive wires 130 can be computed to be included into the disposed area of the total conductive wires 130. In addition, an area extended a line width from a conductive wire 130 closest to the electrostatic protection line 140 and an area between the edge of the touch sensitive area 112 and a conductive wire 130 closest to the edge of the touch sensitive area 112 may be included in the first layout area B1. Furthermore, the electrostatic protection line 140 is disposed on the outer side of the periphery area 114, that is, in the second layout area B2 where the second layout area B2 is equal to the periphery area 114, exclusive of the first layout area B1. Also, another electrostatic protection line 142 (as shown in a partial area A3) can be provided and selectively disposed between two adjacent conductive wires 130 to avoid signal interference occurring to the conductive wires 130. For example, a plurality of first signal conductive wires (such as driving signal conductive wires) can be disposed on one side of the electrostatic protection line 142 and a plurality of second signal conductive wires (such as sensing signal conductive wires) can be disposed on the other side of the electrostatic protection line 142 to avoid signal interference occurring between the first signal conductive wires and the second signal conductive wires. In addition, the line widths of the first signal conductive wires and the second signal conductive wires and the pitch between two adjacent conductive wires can be different. The width of the electrostatic protection line 142 can be smaller than the width of the electrostatic protection line 140. The electrostatic protection line 140 is adjacent to the conductive wires 130, and the width L1 of the electrostatic protection line 140 is greater than the width V of any conductive wires 130. For example, under current manufacturing conditions, the width V of the conductive wires 130 is equal to or smaller than 20 μm. Therefore, the width L1 of the electrostatic protection line 140 can be greater than 20 μm and preferably is greater than 0.2 mm to enhance the effect of electrostatic protection.

Besides, another electrostatic protection line (not illustrated) can be used and selectively disposed between the touch sensitive area 112 and the conductive wires 130 to avoid signal interference occurring between the touch sensitive area 112 and the conductive wires 130.

The electrostatic protection line 140 can be a conductive ring with equal line width extended along and parallel to the border 111 of the substrate 110 and separated from the conductive wires 130 by a predetermined distance. The predetermined distance can be greater than 20 μm and preferably is greater than 0.2 mm to avoid the electrostatic protection line 140 being too close to the conductive wires 130 and causing electrostatic jumping towards the conductive wires 130 in the first layout area B1.

As indicated in the partial areas A1 and A2, the width L1 of the electrostatic protection line 140 remains unchanged, but the distance between the electrostatic protection line 140 and the conductive wires 130 can be adjusted according to the area of the first layout area B1. The quantity of the conductive wires 130 in the partial area A1 is smaller than that in the partial area A2. In the partial area A1, the electrostatic protection line 140 is separated from the outer conductive wire 130 by a distance such as G1 preferably between 20˜250 μm. In the partial area A2, the width L1 of the electrostatic protection line 140 remains unchanged, but the distance between the electrostatic protection line 140 and the outer conductive wire 130 is relatively reduced to be G2 and preferably between 20˜200 μm as the first layout area B1 is expanded outwardly along with the increase in the quantity of conductive wires 130. To summarize, the distance separating the electrostatic protection line 140 from the touch sensitive area 112 can be expressed as: d=GR+nV+(n−1)S+GL. Wherein, GR represents the distance between the electrostatic protection line 140 and the conductive wire 130 closest to the electrostatic protection line 140; n represents the quantity of conductive wires 130; V represents the equal line width of each conductive wire 130; S represents the equal pitch between two adjacent conductive wires 130; GL represents the distance between the edge of the touch sensitive area 112 and the conductive wire 130 closest to the edge of the touch sensitive area 112, and the distance d is between 0.06˜11.52 mm.

As indicated in the partial enlargement of FIG. 2, a plurality of conductive wires 130 are disposed on the inner side of the periphery area 114, that is, in the first layout area B1, for transmitting the touch signal and/or the control signal associated with the touch signal. The first layout area B1 can be an area in which the conductive wires 130 are arranged. Specifically, a disposed area of the total conductive wires 130 is equal to the first layout area B1, for example. Meanwhile, a total of space areas between two neighboring conductive wires 130 can be computed to be included into the disposed area of the total conductive wires 130. In addition, an area extended a line width from a conductive wire 130 closest to the electrostatic protection line 140 and an area between the edge of the touch sensitive area 112 and a conductive wire 130 closest to the edge of the touch sensitive area 112 may be included in the first layout area B1. Furthermore, the electrostatic protection line 140 is disposed on the outer side of the periphery area 114, that is, in the second layout area B2 where the second layout area B2 is equal to the periphery area 114, exclusive of the first layout area B1. Also, another electrostatic protection line 142 (as shown in a partial area C3) can be provided and selectively disposed between two adjacent conductive wires 130 to avoid signal interference occurring between the conductive wires 130.

In another embodiment, an electrostatic protection line (not illustrated) can be used and selectively disposed between the touch sensitive area 112 and the conductive wires 130 to avoid signal interference occurring between the touch sensitive area 112 and the conductive wires 130.

The width of the electrostatic protection line 142 is smaller than the width of the electrostatic protection line 140. The electrostatic protection line 140 is adjacent to the conductive wires 130, and the width of the electrostatic protection line 140 is greater than the width V of any conductive wires 130. FIG. 2 is different from FIG. 1 in that the electrostatic protection line 140 of FIG. 2 is a conductive ring with unequal line width, and is separated from the conductive wires 130 by a constant distance G3 preferably between 20˜50 μm.

As indicated in the partial areas C1 and C2 of FIG. 2, the distance G3 between the electrostatic protection line 140 and the outer conductive wire 130 remains unchanged but the width of the electrostatic protection line 140 can be adjusted according to the area of the first layout area B1. For example, comparison between partial areas C1 and C2, the quantity of conductive wires 130 shown in area 01 is less than the quantity of conductive wires 130 shown in area C2. Therefore the required area of the first layout area B1 in area 01 is smaller. On the contrary, the width of the electrostatic protection line 140 can be relatively increased to be L2. That is, in the partial area C2, as the first layout area B1 is expanded outwardly accompanied with the increase in the quantity of conductive wires 130, the width of the electrostatic protection line 140 is reduced to L3 from L2.

As disclosed in the above two embodiments of the invention, the electrostatic protection line is realized by a conductive ring with equal or unequal line width and the ratio of the area of the electrostatic protection line 140 to the second layout area B2 is adjusted to be between 2%˜95% for adjusting the effect of electrostatic protection. In FIG. 1, the ratio of the area of the electrostatic protection line 140 to the total area of the second layout area B2 has a minimum between 2˜5%. In FIG. 2, the ratio of the area of the electrostatic protection line 140 to the total area of the second layout area B2 has a maximum between 70˜95%.

The electrostatic protection line 140 of the embodiments is a ground line, for example. Based on the electrostatic discharge path, the electrostatic energy accumulated on the substrate 110 will be discharged and grounded via a shortest path. Since the electrostatic protection line 140 is relatively closer to the border 111 of the substrate 110 than the conductive wires 130, the electrostatic energy will be discharged via the nearest electrostatic protection line 140 instead of the conductive wires 130 farther away from the border 111 to avoid the touch panel 100 being damaged by electrostatic energy.

The electrostatic protection line 140 and the conductive wires 130 can be formed by the same or different materials such as copper, silver, nickel, gold or an alloy thereof. As well as metals, the electrostatic protection line 140 can be formed by a transparent conductive material such as indium tin oxide (ITO), aluminum zinc oxide (AZO), indium zinc oxide (IZO), gallium zinc oxide (GZO) or fluorine tin oxide (FTO).

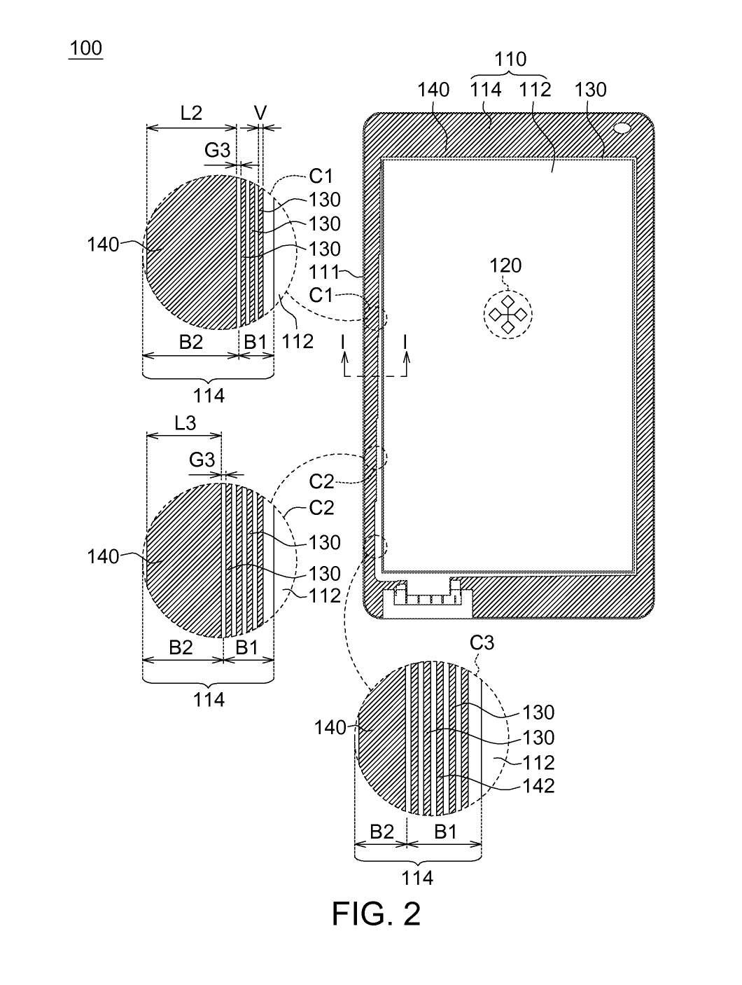

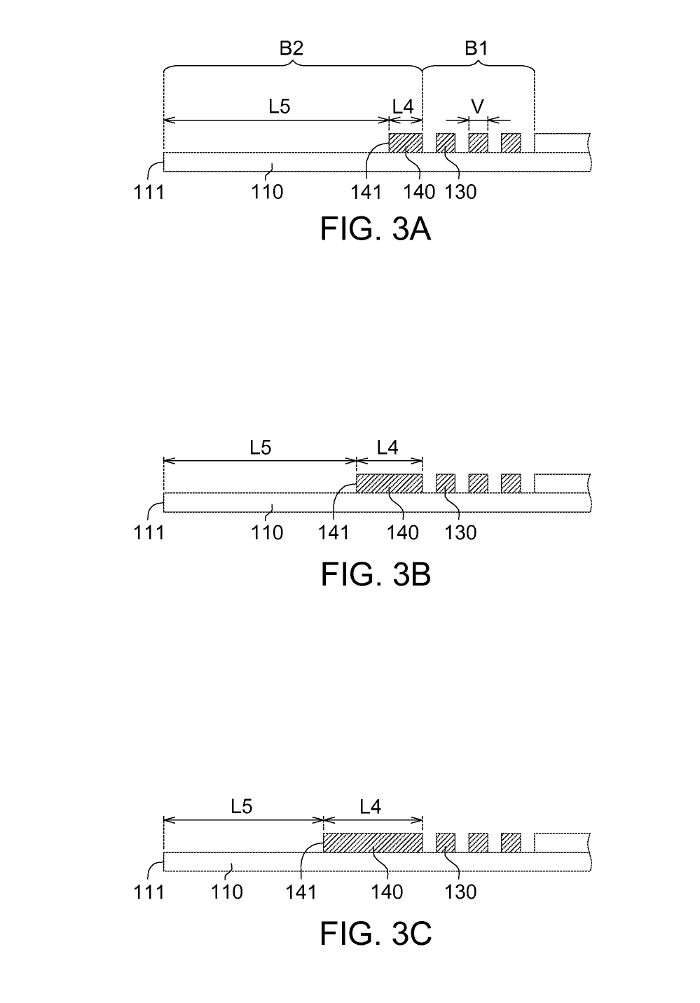

The ratio of the electrostatic protection line 140 to the area of the second layout area B2 can be obtained according to the distance separating the outside of the electrostatic protection line 140 from the border 111 of the substrate 110. Referring to FIGS. 3A˜3E, cross-sectional views of electrostatic protection line having different widths along cross-sectional line I-I of FIG. 1 or FIG. 2 are shown.

Suppose the width of the second layout area B2 is 2 millimeters (mm), and the width L4 of the electrostatic protection line 140 is greater than the width V of any adjacent conductive wires 130. As indicated in FIG. 3A, when the electrostatic protection line 140 occupies 2˜5% of the total area of the second layout area B2, the outside 141 of the electrostatic protection line 140 is separated from at least one border 111 of the substrate 110 by a distance L5 between 1.96˜1.9 mm. As indicated in FIG. 3B, when the electrostatic protection line 140 occupies 15˜25% of the total area of the second layout area B2, the outside 141 of the electrostatic protection line 140 is separated from at least one border 111 of the substrate 110 by a distance L5 between 1.7˜1.5 mm. As indicated in FIG. 3C, when the electrostatic protection line 140 occupies 30˜40% of the total area of the second layout area B2, the outside 141 of the electrostatic protection line 140 is separated from at least one border 111 of the substrate 110 by a distance L5 between 1.4˜1.2 mm. As indicated in FIG. 3D, when the electrostatic protection line 140 occupies 50˜60% of the total area of the second layout area B2, the outside 141 of the electrostatic protection line 140 is separated from at least one border 111 of the substrate 110 by a distance L5 between 1.0˜0.8 mm. As indicated in FIG. 3E, when the electrostatic protection line 140 occupies 70˜85% of the total area of the second layout area B2, the outside 141 of the electrostatic protection line 140 is separated from at least one border 111 of the substrate 110 by a distance L5 between 0.6˜0.3 mm and preferably between 0.32˜0.3 mm. Meanwhile, the width L4 of the electrostatic protection line 140 is between 1.68˜1.7 mm. In this embodiment, the other definition of the first layout area B1 can refer to FIG. 3A. Specifically, the first layout area B1 has a range from the edge of the electrostatic protection line 140 to the edge of the touch sensitive area 112, and the second layout area B2 is equal to the periphery area, exclusive of the first layout area B1.

An experimental result of electrostatic discharge shows that when the distance L5 separating the outside 141 of the electrostatic protection line 140 from at least one border 111 of the substrate 110 is greater than 0.3 mm, the electrostatic energy will decay as the distance L5 increases. That is, the larger the distance L5, the severer the decay of the electrostatic energy.

The above numeric values are for exemplification purpose only, not for limiting the scope of protection of the invention. For example, when the width of the second layout area B2 is between 6˜6.4 mm and the outside of the electrostatic protection line 140 is separated from the border 111 of the substrate 110 by a distance between 0.32˜0.3 mm, the electrostatic protection line occupies around 95% of the total area of the second layout area B2. When the width of the second layout area B2 is between 49˜50.6 mm and the outside of the electrostatic protection line 140 is separated from the border 111 of the substrate 110 by a distance around 48.12 mm, the electrostatic protection line occupies 2˜5% of the total area of the second layout area B2.

In the present embodiment of the invention, the distance L5 separating the outside 141 of the electrostatic protection line 140 from at least one border 111 of the substrate 110 can be adjusted to be smaller than 48.12 mm and greater than or equal to 0.3 mm by adjusting the width of the electrostatic protection line 140 and the ratio of the electrostatic protection line 140 to the total area of the second layout area B2.

In an application of different touch-sensitive products, the distance L5 separating the outside 141 of the electrostatic protection line 140 from at least one border 111 of the substrate 110 is smaller than 14.2 mm and greater than or equal to 0.3 mm, for first example. The distance L5 separating the outside 141 of the electrostatic protection line 140 from at least one border 111 of the substrate 110 is smaller than 23 mm and greater than or equal to 4 mm, for second example. Or, the distance L5 separating the outside 141 of the electrostatic protection line 140 from at least one border 111 of the substrate 110 is smaller than 48.2 mm and greater than or equal to 6 mm, for third example.

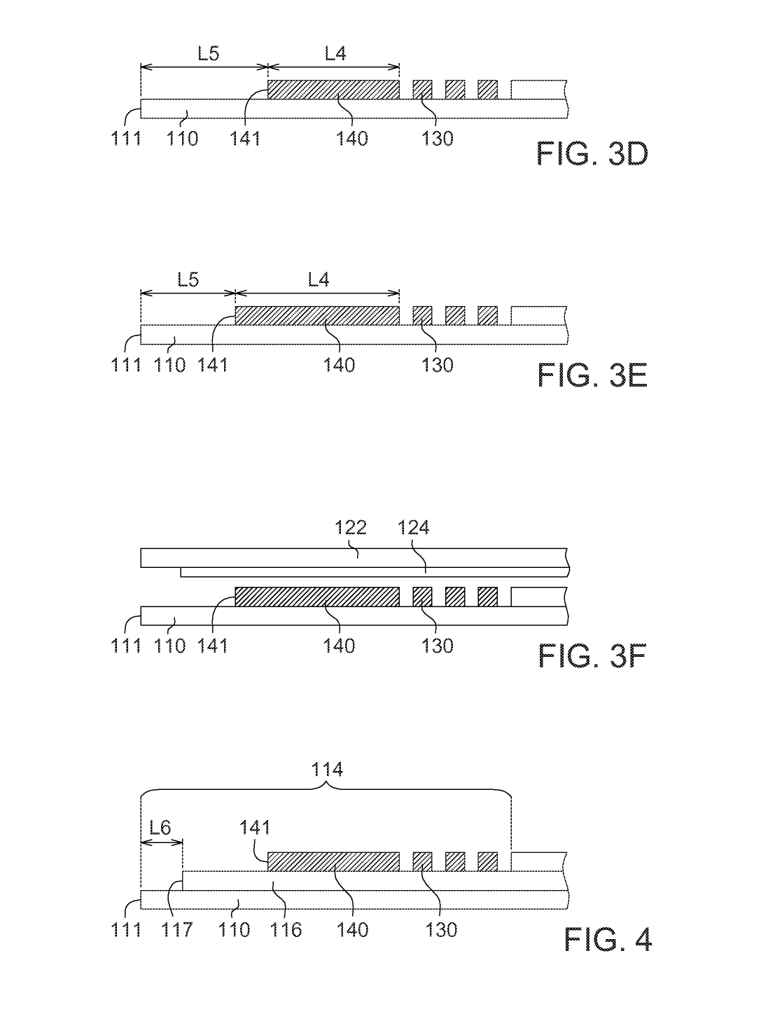

Referring to FIG. 4, a cross-sectional view of a periphery area 114 of a touch panel according to another embodiment of the invention. The substrate (such as a transparent cover plate) 110 of the touch panel further includes a decoration layer 116 disposed in the periphery area 114. The decoration layer 116 can be an opaque ink layer, such that the periphery area 114 becomes an opaque area. A plurality of conductive wires 130 and the electrostatic protection line 140 are disposed on the decoration layer 116, that is, on the inner side of the decoration layer 116. Therefore, when the user looks into the substrate 110 from the outside of the substrate 110, the user can only see the decoration layer 116 but cannot see the conductive wires 130 and the electrostatic protection line 140, such that the aesthetic look of the device will not be affected by the user's visual difference in the periphery area 114.

FIGS. 1, 2 and 3A˜3F illustrate examples of the electrostatic protection line 140 with different line widths. A plurality of conductive wires 130 and the electrostatic protection line 140 disposed on the substrate (glass substrate, plastic substrate, or film) 110 and the decoration layer 124 (please refer to FIG. 3F) disposed on a transparent cover plate 122 (please refer to FIG. 3F) are adhered to each other to form a touch panel with a transparent cover plate adhering to a glass substrate, plastic substrate, or film. The electrostatic protection line 140 of FIGS. 1, 2 and 3A˜3E has different line widths and can be disposed on the decoration layer 116 of FIG. 4, the substrate 110 of FIG. 4 can be realized by a transparent cover plate, and the disposition of line width is not repeated here. Besides, the outside 117 of the decoration layer 116 is separated from the border 111 of the substrate 110 (transparent cover plate) by a distance around 0.55 mm, such that the outside 141 of the electrostatic protection line 140 of the decoration layer 116 is separated from at least one border 111 of the substrate 110 (transparent cover plate) by a distance at least greater than 0.55 mm.

According to the touch panel having electrostatic protection disclosed in above embodiments of the invention, the electrostatic protection line is realized by a conductive ring with equal or unequal line width for enhancing the effect of electrostatic protection. Furthermore, the electrostatic protection line being located in the second layout area does not affect the layout area of the touch panel.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A touch panel having electrostatic protection, comprising:
a substrate having a touch sensitive area and a periphery area surrounding the touch sensitive area, wherein an inner part of the periphery area is a first layout area, and an outer part of the periphery area is a second layout area;
a plurality of sensing electrodes formed in the touch sensitive area;
a plurality of conductive wires disposed in the first layout area; and
an electrostatic protection line disposed in the second layout area and adjacent to the conductive wires, wherein a width of the electrostatic protection line is greater than a width of each of the conductive wires, and a distance separating an outside of the electrostatic protection line from at least one border of the substrate is smaller than 48.12 mm and greater than or equal to 0.3 mm.

2. The touch panel according to claim 1, wherein the first layout area is an area in which the conductive wires are arranged and a disposed area of the total conductive wires is equal to the first layout area, wherein a total of space areas between two neighboring conductive wires is included into the disposed area of the total conductive wires.

3. The touch panel according to claim 1, wherein the second layout area is equal to the periphery area, exclusive of the first layout area.

4. The touch panel according to claim 1, wherein the distance separating the outside of the electrostatic protection line from at least one border of the substrate is smaller than 14.2 mm and greater than or equal to 0.3 mm.

5. The touch panel according to claim 1, wherein the distance separating the outside of the electrostatic protection line from at least one border of the substrate is smaller than 23 mm and greater than or equal to 0.3 mm.

6. The touch panel according to claim 1, wherein the first layout area has a range from the edge of the electrostatic protection line to the edge of the touch sensitive area, and the second layout area is equal to the periphery area, exclusive of the first layout area.

7. The touch panel according to claim 1, wherein the substrate is a transparent cover plate.

8. The touch panel according to claim 1, wherein the electrostatic protection line is a conductive ring with equal or unequal line width.

9. The touch panel according to claim 1, wherein the electrostatic protection line is a ground line, and the line width of the electrostatic protection line is greater than 20 μm.

10. The touch panel according to claim 1, wherein the line width of the electrostatic protection line is adjusted according to the area of the first layout area.

11. The touch panel according to claim 1, wherein the electrostatic protection line occupies greater than 2% and smaller than 95% of the total area of the second layout area.

12. The touch panel according to claim 11, wherein the electrostatic protection line occupies 2˜5% of the total area of the second layout area, and the distance separating the outside of the electrostatic protection line from the border of the substrate is between 1.96˜1.9 MM.

13. The touch panel according to claim 11, wherein the electrostatic protection line occupies 70˜85% of the total area of the second layout area, and the distance separating the outside of the electrostatic protection line from the border of the substrate is between 0.6˜0.3 mm.

14. The touch panel according to claim 1, further comprises a decoration layer disposed on the periphery area, and the conductive wires and the electrostatic protection line are disposed on the decoration layer, the decoration layer is an opaque ink layer.

15. The touch panel according to claim 14, wherein the distance separating the outside of the decoration layer from the border of the substrate is 0.55 mm.

16. A touch panel having electrostatic protection, comprising:
a substrate having a touch sensitive area and a periphery area surrounding the touch sensitive area, wherein an inner part of the periphery area is a first layout area, and an outer part of the periphery area is a second layout area;
a plurality of sensing electrodes formed in the touch sensitive area;
a plurality of conductive wires disposed in the first layout area; and
an electrostatic protection line disposed in the second layout area and adjacent to the conductive wires, wherein a width of the electrostatic protection line is greater than a width of each of the conductive wires, and the electrostatic protection line is separated from an edge of the touch sensitive area by a distance d expressed as: d=GR+nV+(n−1)S+GL, GR represents a distance between the electrostatic protection line and a conductive wire closest to the electrostatic protection line; n represents the quantity of conductive wires; V represents the equal line width of each conductive wire; S represents the equal pitch between two adjacent conductive wires; GL represents a distance between the edge of the touch sensitive area and a conductive wire closest to the edge of the touch sensitive area, and the distance d is between 0.06˜11.52 mm.

17. The touch panel according to claim 16, wherein the first layout area is an area in which the conductive wires are arranged and a disposed area of the total conductive wires is equal to the first layout area, wherein a total of space areas between two neighboring conductive wires is included into the disposed area of the total conductive wires.

18. The touch panel according to claim 16, wherein the second layout area is equal to the periphery area, exclusive of the first layout area.

19. The touch panel according to claim 16, wherein a distance separating the outside of the electrostatic protection line from at least one border of the substrate is smaller than 14.2 mm and greater than or equal to 0.3 mm.

20. The touch panel according to claim 16, wherein a distance separating the outside of the electrostatic protection line from at least one border of the substrate is smaller than 23 mm and greater than or equal to 0.3 mm.

21. The touch panel according to claim 16, wherein the first layout area has a range from the edge of the electrostatic protection line to the edge of the touch sensitive area, and the second layout area is equal to the periphery area, exclusive of the first layout area.

22. The touch panel according to claim 16, further comprising a decoration layer disposed on the periphery area.

23. The touch panel according to claim 16, wherein the substrate is a transparent cover plate.

24. The touch panel according to claim 16, wherein a distance separating the outside of the electrostatic protection line from at least one border of the substrate is between 0.32˜0.3 mm.

25. The touch panel according to claim 16, wherein the electrostatic protection line is a conductive ring with equal or unequal line width.

26. The touch panel according to claim 16, wherein the line width of the electrostatic protection line is adjusted according to the area of the first layout area.

27. A touch panel having electrostatic protection, comprising:
a substrate having a touch sensitive area and a periphery area surrounding the touch sensitive area, wherein an inner part of the periphery area is a first layout area, and an outer part of the periphery area is a second layout area;
a plurality of sensing electrodes formed in the touch sensitive area;
a plurality of conductive wires and a first electrostatic protection line, wherein the conductive wires and the first electrostatic protection line are disposed in the first layout area, and the first electrostatic protection line is disposed between any two adjacent conductive wires of the conductive wires; and
a second electrostatic protection line disposed in the second layout area, wherein the second electrostatic protection line is adjacent to the conductive wires, a width of the second electrostatic protection line is greater than a width of each of the conductive wires, and a distance separating an outside of the second electrostatic protection line from at least one border of the substrate is smaller than 48.12 mm and greater than or equal to 0.3 mm.

28. The touch panel according to claim 27, wherein the first layout area is an area in which the conductive wires are arranged and a disposed area of the total conductive wires is equal to the first layout area.

29. The touch panel according to claim 27, wherein the second layout area is equal to the periphery area, exclusive of the first layout area.

30. The touch panel according to claim 27, wherein the distance separating the outside of the electrostatic protection line from at least one border of the substrate is smaller than 14.2 mm and greater than or equal to 0.3 mm.

31. The touch panel according to claim 27, wherein the distance separating the outside of the electrostatic protection line from at least one border of the substrate is smaller than 23 mm and greater than or equal to 0.3 mm.

32. The touch panel according to claim 27, wherein the first layout area has a range from the edge of the electrostatic protection line to the edge of the touch sensitive area, and the second layout area is equal to the periphery area, exclusive of the first layout area.

33. The touch panel according to claim 27, further comprising a decoration layer disposed on the periphery area.

34. The touch panel according to claim 27, wherein the substrate is a transparent cover plate.

35. The touch panel according to claim 27, wherein the second electrostatic protection line is a conductive ring with equal or unequal line width.

36. The touch panel according to claim 27, wherein the width of the first electrostatic protection line is smaller than the width of the second electrostatic protection line, and the width of the second electrostatic protection line is greater than 20 μm.

37. The touch panel according to claim 27, wherein the width of the second electrostatic protection line is adjusted according to the area of the first layout area.
